(19) United States
(12) Patent Application Publication
(10) Pub. No.: US 2004/0251822 A1
(43) Pub. Date: Dec. 16, 2004

(54) Organic electroluminescent display

(76) Inventors: Jan Birnstock, Dresden (DE); Joerg Blaessing, Oberkochen (DE); Karsten Heuser, Erlangen (DE); Matthias Stoessel, Mannheim (DE); Georg Wittmann, Herzogenaurach (DE)

Correspondence Address: FISH & RICHARDSON P.C., 3300 DAIN RAUSCHER PLAZA, MINNEAPOLIS, MN, 55402, US

(21) Appl. No.: 10/493,893

(22) PCT Filed: Oct. 11, 2002
(86) PCT No.: PCT/DE02/03843

(30) Foreign Application Priority Data
Oct. 26, 2001 (DE) 101 52 919.8

(51) Int. Cl. H05B 33/14; H05B 33/10

(52) U.S. Cl. 313/506; 313/504; 313/500; 445/24

(57) ABSTRACT

An organic electroluminescent display is proposed in which the functional layers (20) are delimited by first strip-like partitions (10) so that large-area application of the functional layers becomes possible. The functional layers are on located on a first electrode layer (5A) on a substrate (1). A second electrode layer (25A) is located on the functional layers.

Organic light-emitting diodes (OLEDs) based on electroluminescent polymers exhibited meteoric development during the last few years. In principle, OLEDs consist of one or several layers of electroluminescent organic materials which are stacked between two electrodes. The materials luminesce upon application of a voltage to the electrodes.

In comparison to the liquid crystal displays which dominate the market of flat screens, OLEDs have a number of advantages. First of all, due to a different physical principle of operation, they are self-emitting so that there is no need for backlighting, which is present as a rule in the case of flat screens based on liquid crystal displays. As a result of this, the space requirement and the electrical power consumption are reduced considerably in the case of OLEDs. The switching times of organic luminescent diodes lie in the region of one microsecond and are only slightly temperature dependent, which makes application for video use possible. In contrast to liquid crystal displays, the reading angle is almost 180°. Polarization films, which are required in the case of liquid crystal displays, are mostly unnecessary, so that greater brightness of the display elements can be achieved. Another advantage is that flexible and nonplanar substrates can be used, and the manufacture is simple and cost-effective.

In the case of OLEDs, there are two technologies which depend on the nature and the processing of organic materials. First of all, low-molecular organic materials can be used, for example, hydroxyquinoline/aluminum(III) salts can be used which are mostly applied by thermal evaporation onto the corresponding substrate. Displays based on this technology are already commercially available and at the present time are mainly used in automobile electronics. Since the manufacture of these components involves numerous process steps under high vacuum, this technology has disadvantages due to high investment and maintenance costs, as well as due to the relatively low throughput.

Therefore, since 1990, an OLED technology has been developed which uses polymers as organic materials, which can be applied from a solution onto the substrate by wet chemical methods. The vacuum steps necessary for the production of organic layers are not present in this technology.

In publication EP 0 892 028 A2 a method is disclosed in which electroluminescent polymers are printed, using an ink-jet printing method, onto the window of a photoresist layer, which defines the individual pixels. The disadvantage of this method lies in the fact that ink-jet printing methods are very slow, so that this type of production methods is very time-consuming and thus cost-intensive.

For this reason, an attempt is made to use large-area printing methods for the printing of the polymers, since these methods can print a large area cost-effectively within a short time. At the present time, the polymers are mostly applied over a large area with the aid of a spin-on method. However, this method has a number of disadvantages. Thus, a large percentage of the polymer solution (approximately 99%) is lost irrevocably and the spin-on method also takes a relatively long time (approximately 30-60 seconds). In the case of large substrates, it is almost impossible to apply polymer layers with a homogeneous thickness.

In principle, quite a number of other large-area standard printing methods are suitable for printing of electroluminescent polymers, for example, planographic processes, such as offset printing, dabber printing or letterpress and gravure printing methods, for example, flexographic printing. A number of standard printing methods for the application of electroluminescent polymers are disclosed in publication WO 099 07189 A1.

However, frequently another problem arises in these large area printing methods. The polymers are not optimized for printability, but for optimum performance regarding sealing conditions, life and electroluminescence efficiency. This means that during the printing of polymers on substrates, some difficulties occur which are not known in the case of classical printing inks or which can be eliminated by modification of these classical printing inks, for example by the addition of additives. One of these difficulties is the running of polymers after printing onto the substrate. Instead of sharp edges, depending on the printing method and application, very broad “smudged edge zones” are obtained. In most cases, the option of adding additives to the polymer solutions to make them printable does not exist, because these additives have an adverse influence on the efficiency of the polymers.

As a result of the running of the polymer solution during printing, the thickness of the polymer layer is reduced, above all at the outer pixels of the display, which leads to inhomogeneous illumination and a reduced life of the display. Furthermore, frequently electrode connectors are made, for example, from an oxidation-resistant electrically conducting material, such as indium-tin oxide (ITO) under a covering, which protects the sensitive polymers as well as the oxidation-sensitive cathode material. In order to provide thick covering on the substrate and on the electrode connecting pieces, it is necessary that these areas be free from polymer. The cathode connecting pieces must therefore be free from polymers, because otherwise the cathode connecting pieces which are applied first onto a substrate will be insulated from the cathode, which is applied later. For these reasons, it is necessary that running of the polymer be avoided in large area printing methods.

The task of the invention is to provide a display based on electroluminescent polymers, which avoids running of the electroluminescent layers during large-area application. This task is solved with a display according to claim 1. Advantageous embodiments of the display, an active-matrix display, as well as methods for the production of the display are the objects of further claims.

In a display according to the invention, a first electrode layer is arranged on a substrate. The functional layers of the display, which can consist of organic, electroluminescent layers are, for example, hole-transport and emitter polymers which are applied onto an area that is delimited according to the invention from the first, strip-like partitions. The functional layers can have a large area within this region. A second electrode layer is located on the functional layers.

Since it is difficult to optimize the functional layers for printability, in the display according to the present invention, the display is modified so that first strip-like partitions prevent the running of the large-area applied functional layers. Only with the aid of this partition structure does it become possible to apply the functional layers onto defined regions of the substrate over a large area and at the same time to limit them so that a uniform remaining thickness is possible even at the edges of the functional layers.

In an advantageous embodiment of the display, the first electrode layer is connected to a first electrode connecting piece in an electrically conducting manner. Neighboring the first electrode layer, at least one second electrode connecting piece is located on the substrate. The second electrode layer then contacts the second electrode connecting piece. The region of the functional layers with the partitions bordering them, as well as the second electrode layer, are covered with a cover, which leaves simultaneously one end of the first and second electrode connecting pieces free.

In this advantageous variation of the display according to the invention, the first strip-like partitions make it possible for the second electrode layer to contact the second electrode connecting piece without any problems, and at the same time a thick covering of the display can be applied, since no running functional layers prevent contact between the cover and the substrate or the electrode connecting pieces.

In another advantageous embodiment of the display according to the invention, a passive matrix display is described. In this display, the first electrode layer has first electrode strips which run parallel to one another, where the extension of each electrode strip serves as a first electrode connecting piece. Transversely to the first electrode strips, second insulating strip-like partitions are arranged which later serve for separation of the second electrode strips. In this arrangement, the first strip-like partitions, alone or together with at least two of the second strip-like partitions, which run transversely to the first partitions, can delimit the functional layers. If, after the production of the functional layers, a second electrode layer is applied over a large area, then the metal film tears off the edges of the second insulating strip-like partitions, so that second electrode strips are formed transversely to the first electrode strips, and each of these are delimited on both sides by a partition of the second insulating partitions. These second electrode strips each contact a second electrode connecting piece applied onto the substrate. In the present passive matrix display, a matrix will contain individually triggerable pixels, where the pixels are defined by the crossing points of the first and second electrode strips. The first electrode strips usually function as anodes, while the second electrode strips are used as cathodes. If a voltage is applied to each of an anode and cathode strip, then the pixel, which is defined as the crossing points of these electrode strips, will light up.

In the case of the passive matrix display according to the invention, in principle, it is possible that, for example, two first insulating partitions which are arranged transversely to the second insulating partitions, delimit the functional layers 20, together with at least two of the second insulating partitions. Furthermore, it is possible to arrange the first insulating partitions in such a way that at least two of them run transversely and two others run longitudinally to the second insulating partitions for the separation of the cathode, where the first four insulating partitions together delimit the functional layers. Since frequently multilayer functional layers are used, which, for example, consist of polar or nonpolar polymers, such as hole-transport or emitter polymers, for example, it is also possible that the first insulating partition structure is delimited by another insulating partition structure, where the two partition structures may have different wettability for polar and nonpolar functional layers. The first insulating partitions for delimiting the functional layers and the second insulating partitions for cathode separation can, however, also be made of the same material.

In the case of a passive matrix display, the first and second insulating partitions can advantageously be made from the same material. This has the advantage that the first insulating partitions for the delimiting of the functional layers can be produced in one process step with the partitions for cathode separation. As materials, for example, positive or negative photoresists or other insulating, layer-forming materials, for example, silicon dioxide are suitable.

The second insulating partitions for the separation of the cathode advantageously have an edge shape which overhangs on top so that later the metal film applied over a large area (second electrode layer) can be torn off reliably at the edges of the second insulating partitions. If the first insulating partitions for delimiting the functional layers are applied together with the second insulating partitions, then in this case these also usually have an overhanging edge shape. In this case it is advantageous that at least those first insulating partitions transverse to the second insulating partitions, which neighbor the second electrode connecting pieces (cathode connecting pieces) be formed of at least two regions which are not connected to each other. The advantage of this is that, in spite of the overhanging edge shapes of the first insulating partitions, due to their interrupted partition structure, tearing off the second electrode film at the boundary to the electrode connecting pieces can be reliably prevented upon large-area application, so that the second electrode strips are in electrical contact with the second electrode connecting pieces.

The object of the invention is also a method which provides for producing a first electrode layer in process step A). A first insulating layer can be applied onto the substrate and/or onto the first electrode layer and then can be structured to first strip-shaped partitions in a process step B). In this case, it is also possible to first produce the first strip-like partitions and then the first electrode layer, that is, first process step B) and then process step A) is performed. Then, in a process step C), the functional layers are applied over a large area onto the first region delimited by the first strip-shaped partitions and then in a process step D) a second electrode layer is applied over a large area onto the functional layers. The display according to the invention is explained below in more detail together with its method of preparation and with the aid of practical examples and figures.

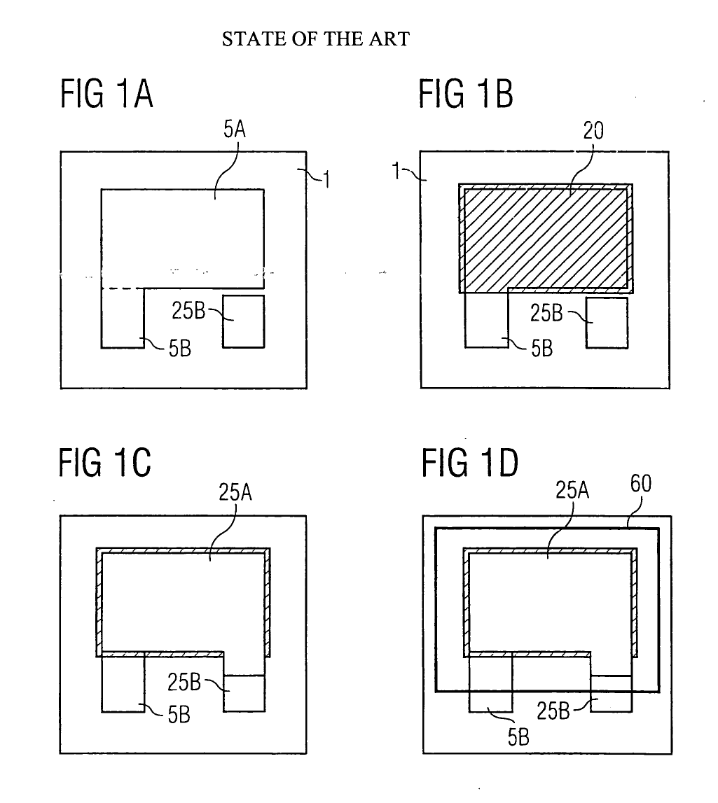

FIGS. 1A to 1D show the preparation of a conventional display with non-structured first and second electrode layers.

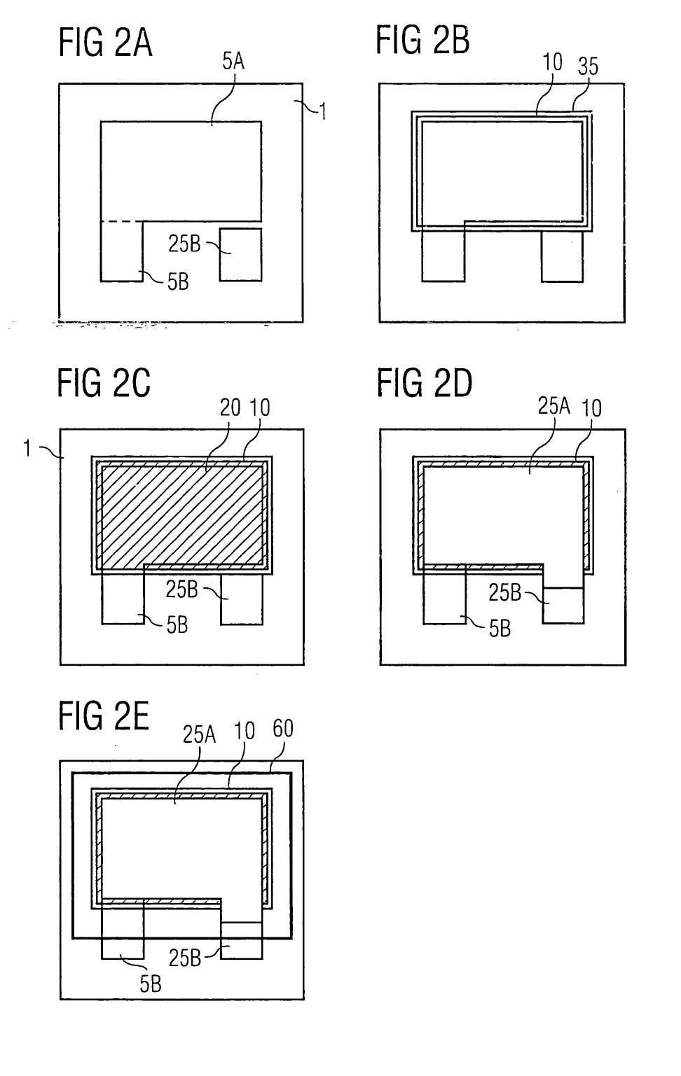

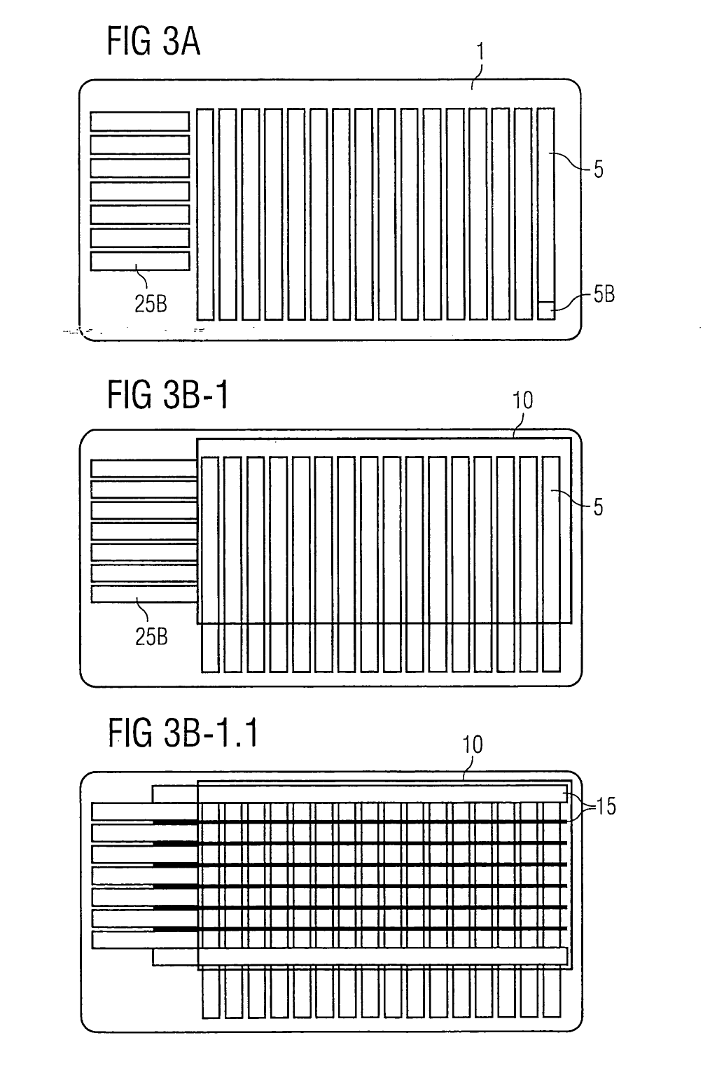

FIGS. 2A-2E show the preparation of a variant of a display according to the invention with non-structured first and second electrode layers and electrode connecting pieces.

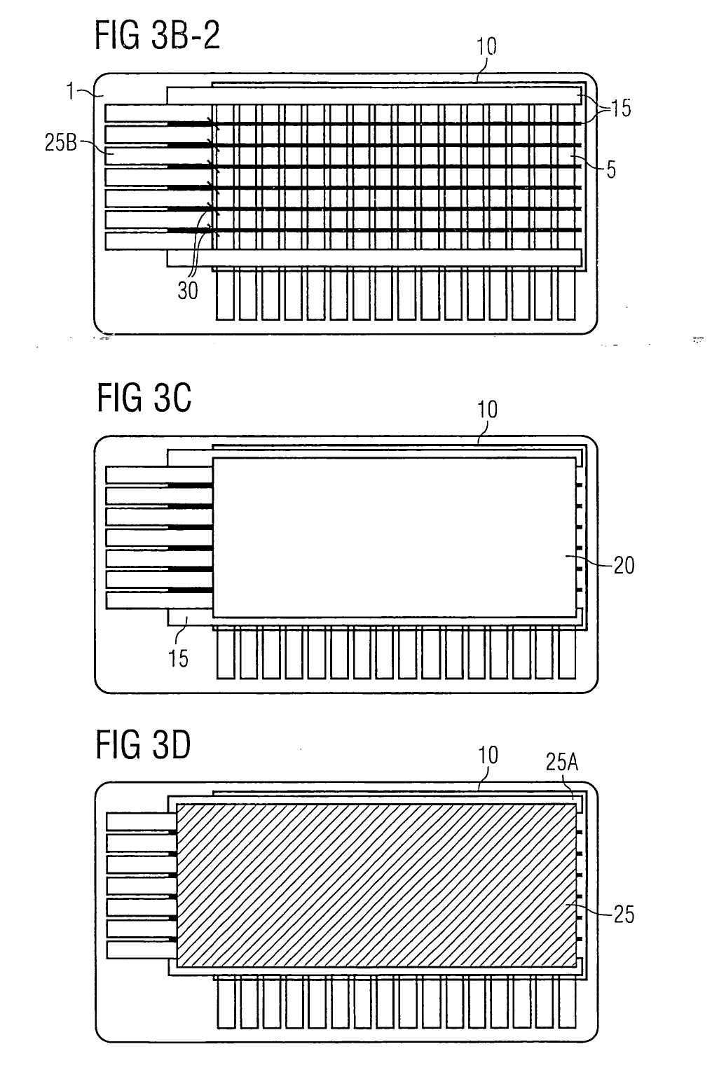

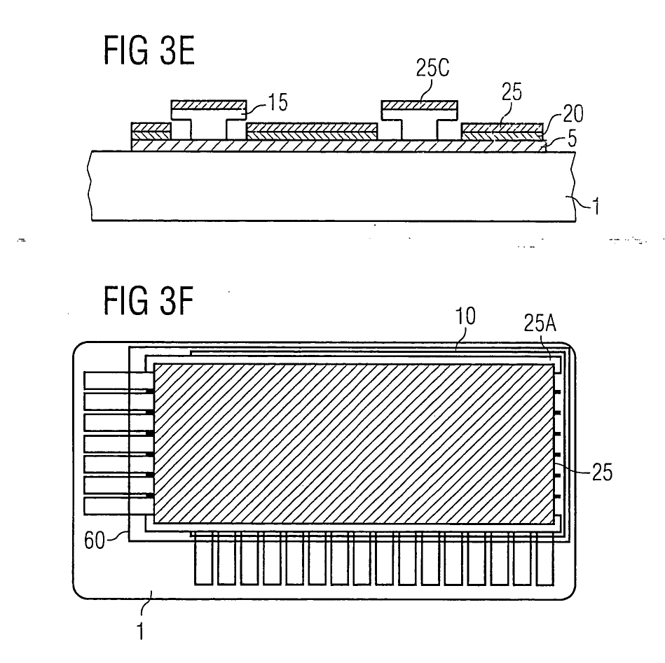

FIGS. 3A-3F show the preparation of a passive matrix display according to the invention with structured first and second electrode strips.

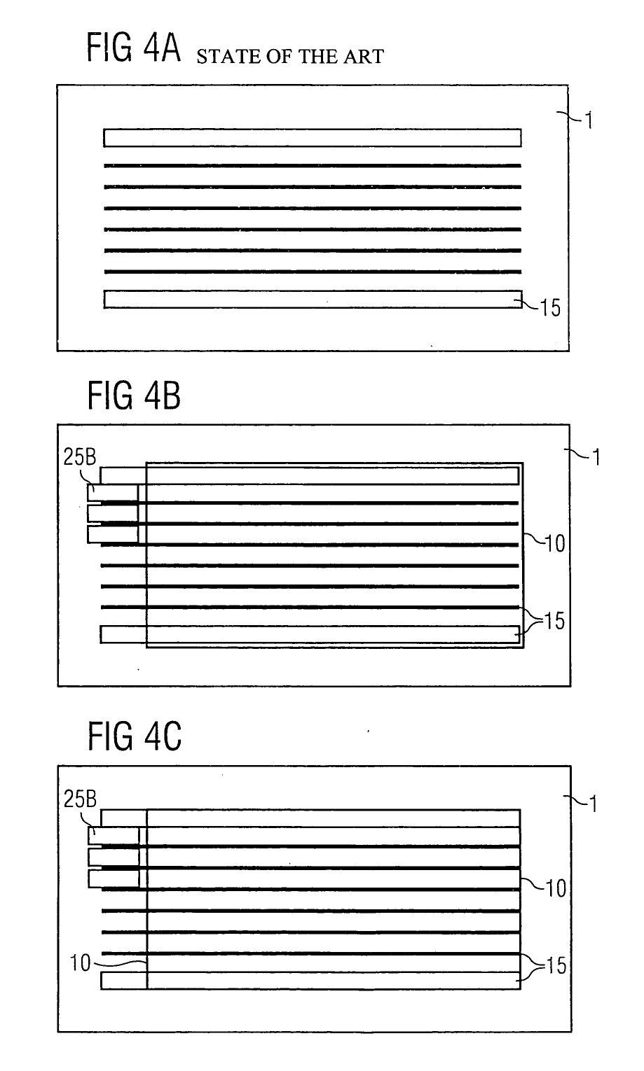

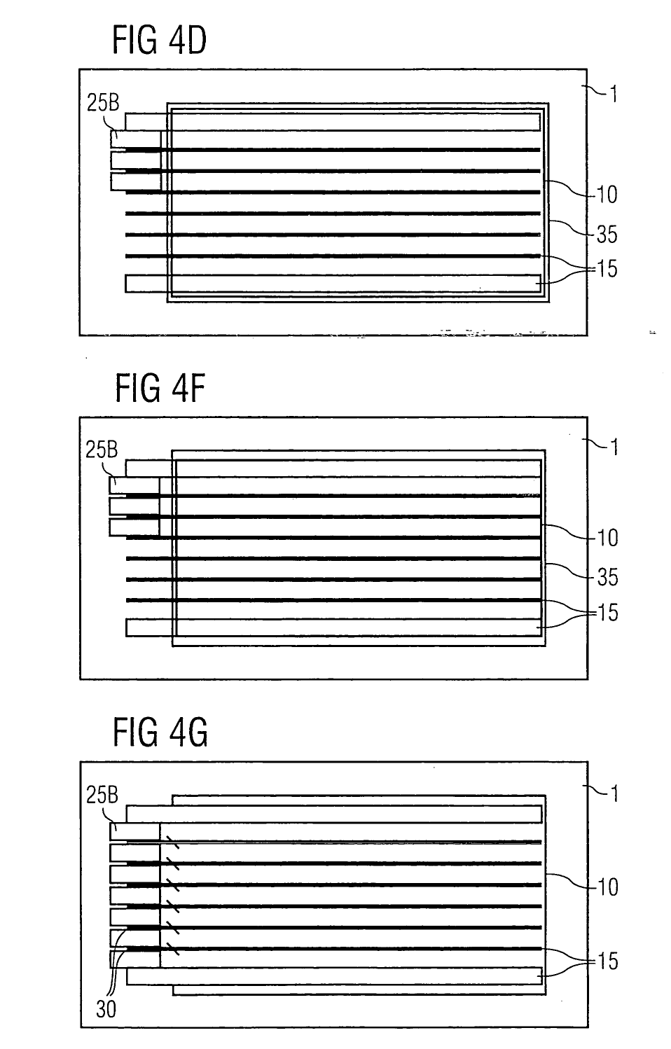

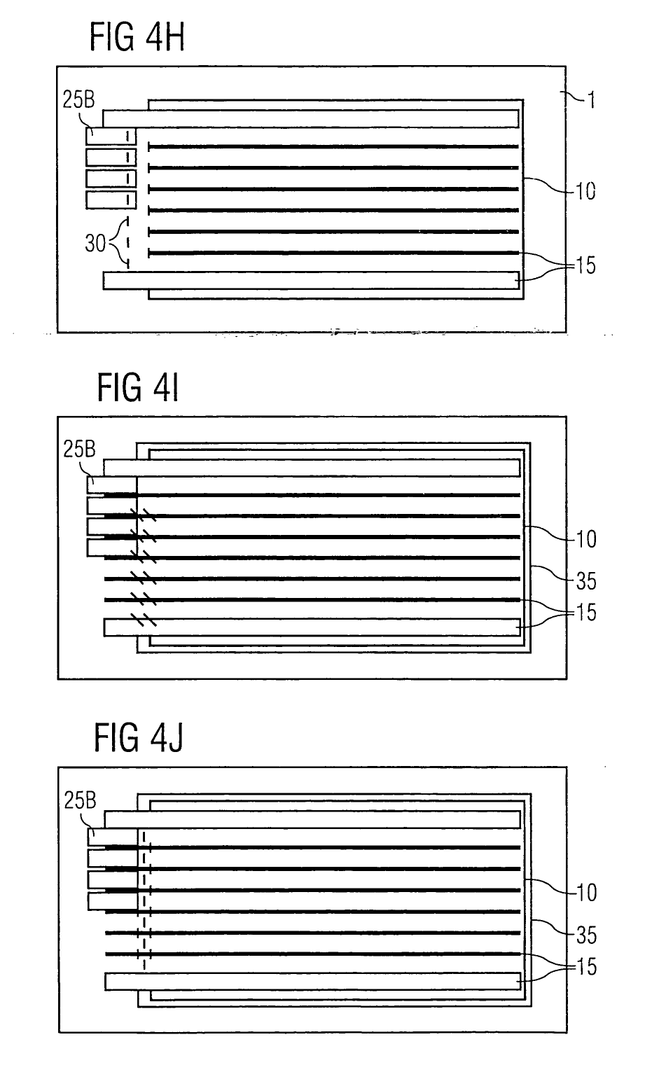

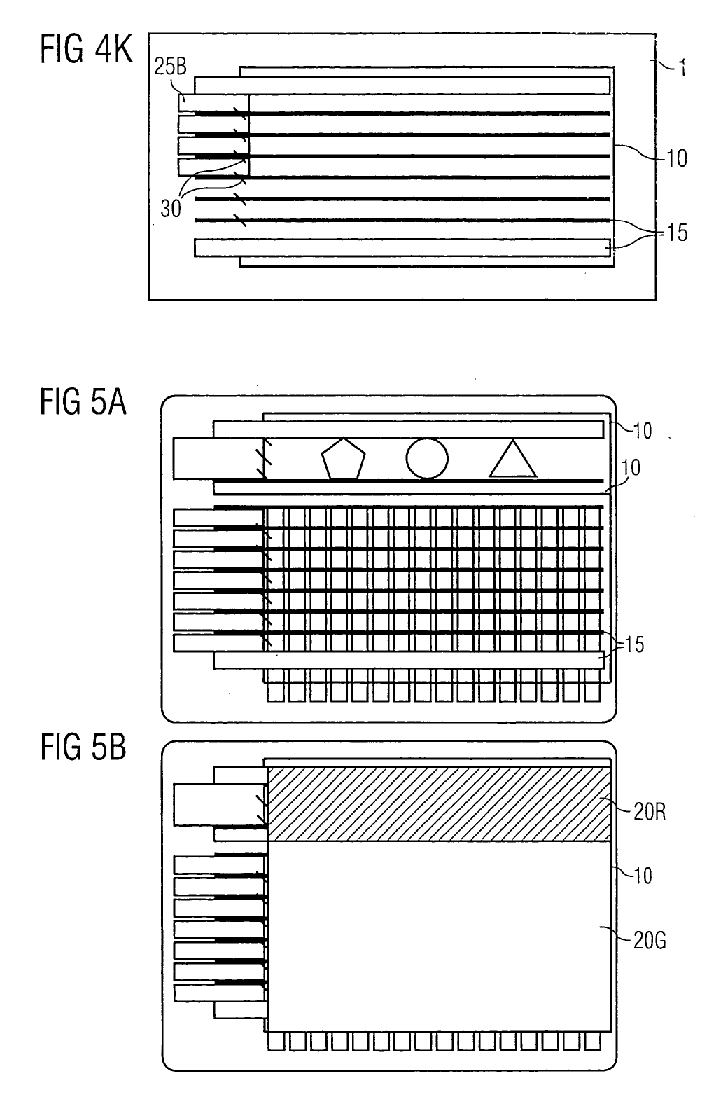

FIGS. 4A-4K show conventional second strip-like partitions for structuring the cathode (second electrode strips) and combinations of the second strip-like partitions and the first strip-like partitions according to the invention to delimit the functional layers.

FIGS. 5A and 5B show a possibility of delimiting functional layers from one another which show different-colored electroluminescence using a combination of the first and second strip-like partitions.

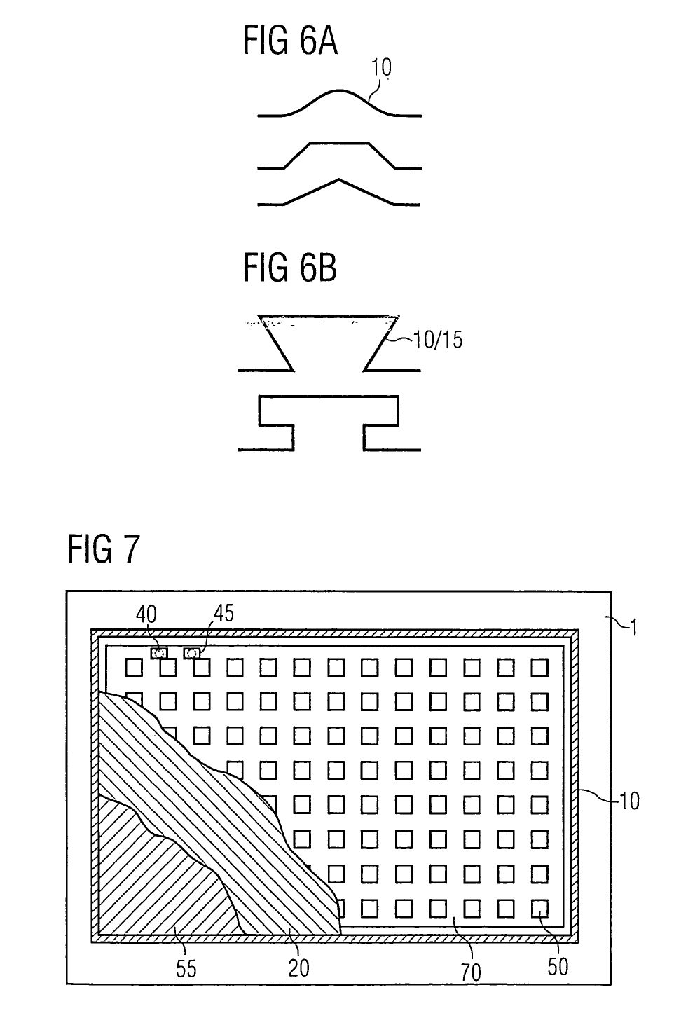

FIGS. 6A and 6B show the cross-sections of partitions with and without overhanging edge shapes.

FIG. 7 shows an active-matrix display according to the invention.

In order to illustrate the differences between a conventional display and one according to the invention, and of their methods of preparation, respectively, below a method of manufacture for a conventional display with non-structured first and second electrode layers and electrode connecting pieces, for example, for illumination applications, will be discussed briefly.

In a conventional method of manufacture, in a first process step, such as shown in FIG. 1A, a first electrode layer 5A, with a directly electrically connected first electrode connecting piece 5B as well as a second electrode connecting piece 25B, electrically insulated from the above, is produced on a transparent substrate 1, for example, on a glass disk. Usually indium-tin oxide (ITO) is used as material for the electrode layer as an electrically conducting transparent material.

In FIG. 1B, in a second process step, a layer of functional polymer 20 is applied over a large area. The functional layer 20 should not cover any areas of the second electrode connecting piece 25B or of the first electrode connecting piece 5B, since these areas will be passed through a cover to be applied later, and when functional layers are present on these connecting pieces, tight coverage would no longer be possible. Furthermore, care must be taken also that the functional layers 20 will not cover any other areas on substrate 1 onto which later the cover is applied.

In a next process step (FIG. 1C), finally a large-area second electrode layer 25A is applied, for example with the aid of a shadow mask, the electrode layer consisting, for example, of aluminum, whereby care must be taken that this second electrode layer is in contact with the second electrode connecting piece 25B.

In a last process step, as illustrated in FIG. 1D, a covering 60 is applied over the areas of the functional layers and the second electrode layer covering it, where the two electrode connecting pieces 5B and 25B under the cover are passed through.

In contrast to the conventional manufacturing method for a display shown above, a variation of the manufacturing method according to the invention is characterized by the fact, as explained below, that at least one additional process step is included in which strip-like partitions are applied to delimit the functional layers. This variation also includes the production of first and second electrode strips as well as the application of an encapsulation. In its most general form, the method according to the invention, as already mentioned above, includes only process steps A) to D) where neither electrode connecting pieces nor encapsulation are produced.

The variation of the method according to the invention is characterized by the fact that, in a first process step A), as shown in FIG. 2A, a first electrode layer 5A with a first electrode connecting piece 5B and next to it at least one second electrode connecting piece 25B are produced on a substrate 1. In this case too, usually indium-tin oxide is used as the transparent electrically conducting electrode material. This can be structured easily with liquid HBr.

In a second process step B), a first insulating layer is applied onto the substrate and/or the electrode layer and then it is structured to form strip-like partitions 10 in such a way that these delimit the area on which later the functional layers 20 are produced. This process is shown in FIG. 2B, where advantageously the first insulating strip-like partitions 10 are surrounded by other strip-like partitions 35 which preferably run parallel to them and which can be made of materials other than the first strip-like partitions 10, so that it is possible to delimit several different functional layers by the two partition structures 10 and 35, for example, one of which can be a hydrophilic layer and the other a hydrophobic layer. In this case it is then possible to delimit the first functional layer by the first strip-like partitions 10 and the second functional layer by the partition structure 35.

In a process step C) then as shown in FIG. 2C, the function layers 20 are applied over a large area, where, as already mentioned, several layers can be applied.

In a subsequent process step D), a second electrode layer 25A is produced over a large area on the functional layers 20 in such a way that it contacts the second electrode connecting piece 25B. This process step is shown in FIG. 2D. The second electrode layer can, for example, be evaporated over a large area through a shadow mask.

In a last process step E) then as shown in FIG. 2E, a covering 60 is applied in such a way that it covers the area of the functional layers 20 and the partitions 10 and 35 delimiting it, the second electrode layer 25A and always one end of the first and second electrode connecting piece. The material of the covering can be, for example, a plastic.

The advantage of this variation of the method according to the invention consists in the fact that, based on the first strip-like partitions 10 according to the invention, functional layers 20 applied over a large area can be delimited, so that it is possible to apply a cover 60 without any problem, which tightly closes with the transparent substrate 1 and the electrode connecting pieces 5B and 25B, since no functional layers are located on these areas that would prevent tight encapsulation.

A method is described below for the preparation of a passive matrix display according to the invention with structured first and second electrode strips, as well as a matrix of individually controllable pixels.

In this method, in process step A), as shown in FIG. 3A, the first electrode layer 5A is structured into the first electrode strips 5 running parallel to one another, where the extension of each of the electrode strips 5 functions as first electrode connecting piece 5B. The second electrode connecting pieces 25B are arranged neighboring one of the outer electrode strips 5.

Since in this method second strip-like partitions 15 are also arranged on the substrate for structuring the second electrode strips (cathode strips), it is possible to apply the first strip-like partitions 10 for delimiting the functional layers in one process step B), as shown in FIG. 3B-1 and to structure separately from this the second strip-like partitions 15 in a separate process step B1), as shown in FIG. 3B-1.1. Here it is possible to produce the second strip-like partitions before or after the first strip-like partitions. This method of operation has the advantage that, after the structuring of one or both strip-like partitions 10 or 15, these can be modified on the surface by an additional treatment. For example, one can passivate one of the two strip-like partitions structures against wetting by solvent by etching them in a fluorinating plasma, for example CF₄. It is also possible to treat the partitions with surface-active substances, for example with surfactants or detergents. In this way, the partition structures can be pretreated depending on whether they have to be wetted by polar or nonpolar solvents of the functional layers. The chemical and mechanical stability of partitions, which, for example, can be made of polyvinyl alcohol, can also be improved by treatment with chemical hardeners. During hardening, the polymer is cross-linked additionally, whereupon the wetting behavior of the partitions is altered.

The additional modification of the surface of one of the two insulating partitions, as well as their separate structuring and application independently of the other insulating partitions has the advantage that the two partition structures can always be adapted individually according to the existing problem (first insulating partitions=delimiting of the functional layers, second insulating partitions=separation of the cathode strips). By separate structuring of the two partition structures, among others, the shape and the dimensioning of each partition structure can be adapted to quite individual conditions. Thus, for example, the second insulating partitions can be structured with overhanging edges, as shown in FIG. 6B, on which then the second electrode layer of the metal film applied later can be torn off, while the first insulating partitions do not have any overhanging edge shape.

In any case, it is also possible to produce the first and second strip-like partitions from the same material and to structure them together in one common process step B). The advantage of this is that they can be produced together in a single process step rapidly and cost-effectively. Based on the common structuring, then both the first as well as the second partitions can have the same overhanging edge shape. In this case, advantageously, that first strip-like partition which is neighboring the second electrode connecting pieces 25B can be designed in such a way that it consists of regions 30 which are not bonded to one another, which interrupt the partition in its length, for example as shown in FIGS. 4G and 4H. As before, such a structuring permits delimiting the functional layers, but also prevents universal tearing of the metal film on this first partition during application of the second electrode layer, so that this can furthermore contact the second electrode connecting pieces. It is also possible that these regions (30), which are not connected to one another run transversely to the longest extension of the first partition, as shown in FIG. 4G.

The second insulating partitions 15 are usually structured transversely to the first electrode strips 5. As materials for the first and second strip-like partitions, mainly all structurable insulating materials come into consideration. Thus, for example, it is possible to use positive or negative photoresists, to apply these over a large area onto the substrate 1 after structuring of the first electrode strips and then to illuminate these and develop them with the aid of a developer. However, for example, it is also possible to use other insulating layer-forming materials, for example, silicon dioxide, which then can be structured by a shadow mask with the aid of an etching plasma. For example, it is also possible to use polyimide plastics, which can be structured through a mask with solvents that act specifically on the polyimide. Furthermore, it is possible to apply the insulating material both of the first as well as of the second insulating partitions with the aid of a printing process.

In principle, it is also possible that only the first insulating strip-like partitions 10 delimit the functional layers and thus also at least the majority of the second strip-like partitions 15 delimit for the purpose of cathode separation. However, for example, it is also possible that the first strip-like partitions which are transverse to the second strip-like partitions are formed together with at least two of these second strip-like partitions into a coherent partition structure which delimits the functional layers, for example, as shown in FIG. 4C.

Then, as shown in FIG. 3C, in process step C) the functional layers 20 can be applied over a large area. For large-area application of the functional layers 20, for example, large area printing methods are suitable such as offset printing, screen printing, dabber printing, gravure printing and letterpress printing methods, especially flexographic printing. In flexographic printing we are dealing with a rotary roll printing method in which, for example, flexible printing patterns made of rubber or plastic can be used.

Then, in process step D), as shown in FIG. 3D, the second electrode layer 25A is applied over a large area, for example through a shadow mask, whereby the metal film on the second strip-like partitions tears off, so that the second electrode strips 25 can be formed, which are delimited on both sides by a partition on each side of the second insulating layer. FIG. 3E shows an OLED display in cross-section after the large-area application of the second electrode layer in process step D), whereby the second electrode strips 25 are produced. Here, upon tearing off the metal film, a metal layer 25C is also formed on the cap of the second partitions 15, which does not have any contact to the second electrode strips. The second electrode strips contact the second electrode connecting pieces 25B. In a last process step E), finally, as shown in FIG. 3F, a covering 60 is applied, which covers the functional layers, the second electrode strips 25 located on top of them, as well as one end each of the first and second electrode connecting pieces.

Since in this method, too, for the preparation of a passive matrix display according to the invention the functional layers are covered either by only the first strip-like partitions 10 or by a combination of the first 10 and second strip-like partitions 15, in this case too, tight covering 60 of the displays is possible in a simple manner.

In this method according to the invention a number of combinations of first and second strip-like partitions is possible. If the first strip-like partitions are structured separately before the second strip-like partitions, then it is possible to structure continuous first partition structures without overhanging edge shapes, as shown in FIGS. 4B to 4F. In this case, it is possible that only the first strip-like partitions form a coherent partition structure, which delimits the functional layers as shown in FIG. 4B. Then, furthermore, it is possible that only the two first strip-like partitions 10, which stand perpendicularly to the second strip-like partitions, form, together with at least two of these outermost strip-like second partitions, a coherent partition structure which delimits the functional layers, as shown in FIG. 4C. As already mentioned, it is also possible that the first strip-like partitions 10 are surrounded by additional strip-like annularly closed partitions 35, which offer an additional protection against the running of the functional layers (see FIG. 4D). It is shown in FIG. 4F that an inner delimiting consisting of two first and two second strip-like partitions can also be surrounded by at least four additional partitions 35.

If the first and second strip-like partitions are structured together, then it is advantageous that, based on the overhanging edge form of the structured partitions, that first strip-like partition which is in the neighborhood of two electrode strips 25B consists of interrupted regions 30, so that tearing off the metal film at this first partition can be prevented. In this case, it is possible for the regions 30 to stand transversely to the second strip-like partitions, as shown in FIG. 4G or to stand perpendicularly to the second strip-like partitions, whereby parallel displaced structures are possible, as shown in FIG. 4H. However, in this case, it is also possible to construct several partition structures parallel to one another which stand always perpendicularly or at a slant to the second strip-like partitions, as shown in FIGS. 4I to 4J.

Advantageously, the second strip-like partitions can also be led out over the region of the functional layers and the first insulating partitions limiting them, as shown in FIGS. 4K and 4B to 4F, whereby in this case the second electrode connecting pieces 25B are guided between the second strip-like partitions. The variation shown in FIG. 4K with interrupted regions 30 transversely structured to the second partitions is also possible for the other examples with interrupted partition structures shown in FIGS. 4G to 4J.

FIG. 5A shows a passive matrix display according to the invention with an icon bar (symbol strip) before the application of the functional layers 20. In this variation the first strip-like partitions 10 also delimit regions into which functional layers 20R and 20G with different-colored electroluminescence can be applied, as shown in FIG. 5B. As a result of this, it is possible, for example, to provide the icon bar with functional layers, which electroluminesce in a different color than the rest of the display.

FIG. 6A shows some examples of cross-sections of the first insulating partitions 10 without overhanging edge shape. These edge shapes make reliable delimiting of the functional layers 20 possible, and at the same time, however, they also prevent tearing off the metal film when the second electrode layer is applied.

FIG. 6B shows some examples of cross-sections of partitions with overhanging edge shape. These are realized advantageously in the second insulating partitions for separation of the cathode strips. In case of the possible common structuring of the first and second strip-like partitions from the same material, frequently also the first strip-like partitions are formed to delimit the polymer so that they have overhanging edge shapes. In this case, as already mentioned, it is advantageous to produce those first insulating partitions shown in FIG. 4G to 4K which are neighboring the second electrode strips 25B in the interrupted form.

The partition structures according to the invention for delimiting the functional layers can be used in various constructions of OLED displays in which, for example, because of a covering, running of the functional layers should be prevented. These also include, for example, active-matrix screens.

FIG. 7 shows an example of the structure of an active-matrix display according to the invention with first strip-like insulating partitions 10 for delimiting the functional layers 20. In an active-matrix display, advantageously a matrix of individually triggerable pixels is created by the fact that each image point is provided with at least one individually triggerable semiconductor component 40, for example a transistor, which is connected in an electrically conducting manner to a first electrode 45 and is arranged next to the windows 50 under an insulting layer 70. The insulating layer 70 makes sharp delimiting of the individual pixels from one another possible and delimits the semiconductor components from the functional polymers. On the window structure with the semiconductor components and first electrodes located within, the functional layer 20 can be arranged over a large area and then a second electrode layer 55 can be arranged over a large area.

In case of a transparent substrate, on the side facing the viewer of substrate 1, frequently a mirror effect and/or a screen effect may occur which can disturb the view through the transparent substrate to the OLED and is experienced as being disadvantageous. This reflection can be prevented by roughening at least partial regions on the transparent substrate 1 which faces the viewer, for example, by sandblasting of a glass plate, so that the substrate will be matted. The matting is produced by small microscopic recesses on the surface. Each such recess acts as a scattering center for the emitted light. As a result of the diffuse distribution of light the disturbing screen and/or mirror effect is eliminated.

It is possible that some partitions of the second insulating layer also structure graphic elements of the display. Since these partitions advantageously have an overhanging edge form, for example, closed outlines of graphic elements can be structured with parts of these partitions, which then enclose a region which can be insulated from the remainder of the second electrode layer and therefore will appear nonlit and dark.

The invention is not limited to the concretely described practical examples. Naturally, further variations especially with regard to the materials used for the partitions for delimiting the functional layers, the geometry of the display and the exact process steps for the manufacture of the display are also within the framework of the invention. For example, a display which consists of a nontransparent substrate with a nontransparent first electrode layer is also possible, whereby in this case the second electrode layer and the covering are transparent in order to make emission of the light from the display possible.

1-31. (Cancelled)

32. An organic electroluminescent display, comprising:
a first electrode layer supported by a first surface of a substrate;
a functional layer supported by the first electrode layer;
a first strip-like partition delimiting the functional layer, the first strip-like partition supported by the first surface of the substrate; and
a second electrode layer supported by the functional layer.

33. The display of claim 32, further comprising:
a first electrode connecting piece electrically connected to the first electrode layer;
a second electrode piece supported by the first surface of the substrate and electrically connected to the second electrode layer; and
a cover covering the functional layers the strip-like partition, the second electrode layer, one end of the first electrode connecting piece and one end of the second electrode connecting piece.

34. The display of claim 33, wherein:
the first electrode connecting piece is adjacent to the second electrode connecting piece and the first electrode connecting piece is electrically insulated from the second electrode connecting piece.

35. The display of claim 32, wherein:
the first electrode layer includes parallel first electrode strips;
one end of each first electrode strip serves as an electrode connecting piece;
the second electrode layer includes second electrode strips that are arranged transversely to the first electrode strips, the display further comprising:
second strip-like partitions arranged transversely to the first electrode strips and delimiting the second electrode layer.

36. The display of claim 35, wherein:
the first and second strip-like partitions delimit the functional layer.

37. The display of claim 36, including at least two first strip-like partitions wherein:
the at least two first strip-like partitions are arranged transversely to the second strip-like partitions; and
the at least two first strip-like partitions and the second strip-like partitions delimit the functional layer.

38. The display of claim 36, including at least four first strip-like partitions wherein:
a first two of the at least four first strip-like partitions run transversely to the second strip-like partitions;
a second two of the at least four first strip-like partitions run longitudinally to the second strip-like partitions; and
the at least four first strip-like partitions delimit the functional layer and the second strip-like partitions.

39. The display of claim 38, further comprising:
at least four third strip-like partitions delimiting the at least four first strip-like partitions.

40. The display of claim 38, wherein:
the first and second strip-like partitions are made from a first material.

41. The display of claim 38, wherein:
at least one of the at least four first strip-like partitions that runs transversely to the second strip-like partitions include a first portion and a second portion, wherein the first portion has a first height and the second portion has a second height that is less than the first height.

42. The display of claim 38, wherein:
at least one of the at least four first strip-like partitions that runs transversely to the second strip-like partitions include a first portion and a second portion, wherein the first portion is not connected to the second portion.

43. The display of claim 42, wherein:
the first portion is not parallel to the second portion.

44. The display of claim 35, wherein:
the second strip-like partition has a cross-section with an overhanging edge.

45. The display of claim 35, wherein:
the functional layer has a first portion and a second portion, the first portion electroluminesces a first color and the second portion electrodluminesces a second color, the first color is different from the second color; and
the first strip-like partition delimits the first portion from the second portion.

46. The display of claim 32, wherein:
the first partition forms an outline of a graphic element.

47. The display of claim 32, wherein:
the substrate includes a transparent material has a matted second surface.

48. An organic electroluminescent active-matrix display, comprising:
a matrix of individually addressable semiconductor components including first electrodes supported by a substrate, an insulator layer having windows arranged adjacent to the semiconductor components;
a functional layer contacting the insulating layer;
strip like first insulating partitions around the insulating layer and delimiting the functional layers; and
a second electrode layer supported by the functional layer.

49. A method for forming an organic electroluminescent display, comprising:
forming a first electrode layer on a substrate;
forming a first insulating layer into strip-like partitions on the substrate;
applying a functional layer over a large area of the substrate such that the strip-like partitions delimit the functional layer; and
forming a second electrode layer over the large area of the substrate and the first functional layer.

50. The method of claim 49, wherein:
forming the first electrode layer includes forming a first electrode connecting piece and a second electrode piece, such that an electrode of the first electrode layer is electrically connected to the first electrode connecting piece;
forming the second electrode layer includes connecting the second electrode connecting piece to an electrode of the second electrode layer; and
applying a cover over the functional layer, the strip-like partitions, the second electrode layer and a first end of the first electrode connecting piece and a first end of the second electrode connecting piece.

51. The method of claim 49, wherein:
forming the first electrode layer includes structuring parallel first electrode strips;
forming a second electrode layer includes structuring the second electrode layer into second electrode strips, the method further comprising:
forming a second insulating layer in partitions transverse to the first electrode strips, such that the second insulating layer partitions delimit the second electrode strips.

52. The method of claim 51, wherein:
the steps of forming the first strip-like and forming the second partitions insulating layer occur simultaneously.

53. The method of claim 51, wherein:
the second insulating layer is formed into partitions separately from the first insulating layer being formed into strip-like partitions.

54. The method of claim 53, wherein:
forming the second insulating layer includes a step of treating the first insulating layer partitions followed by a step of forming the second insulating layer into the partitions.

55. The method of claim 54, wherein:
the step of treating the first insulating layer partitions includes etching with a fluorinating plasma to passivate the second insulating layer against wetting.

56. The method of claim 54, wherein:
the step of treating the first insulating layer partitions includes chemically treating the first insulating layer partitions with surface-active substances.

57. The method of claim 54, wherein:
the step of treating the first insulating layer partitions includes chemically treating the first insulating layer partitions with chemical hardeners.

58. The method of claim 51, wherein:
forming the first and second insulating layers includes forming at least two partitions of the second insulating layer and the strip-like partitions of the first insulating layer to delimit the functional layer.

59. The method of claim 51, wherein:
forming the first insulating layer includes forming the first insulating layer of a photoresist.

60. The method of claim 51, wherein:
forming the second insulating layer includes forming the second insulating layer of a photoresist.

61. The method of claim 51, wherein:
forming the first insulating layer includes printing the first insulating layer.

62. The method of claim 51, wherein:
forming the second insulating layer includes printing the second insulating layer.

63. The method of claim 51, wherein:
forming the first insulating layer includes etching the first insulating layer with a plasma to form the strip-like partitions.

64. The method of claim 51, wherein:
forming the second insulating layer includes etching the second insulating layer with a plasma to form the partitions.

65. The method of claim 51, wherein:
forming the first insulating layer includes treating the first insulating layer with a solvent to form the strip-like partitions.

66. The method of claim 51, wherein:
forming the second insulating layer includes treating the second insulating layer with a solvent to form the partitions.

67. The method of claim 51, wherein:
forming the first insulating layer includes forming the first insulating layer with a first material; and
forming the second insulating layer includes forming the second insulating layer with a second material, the first material being different from the second material.

68. The method of claim 49, wherein:
applying the functional layer includes printing the functional layer with a large-area printing process.

69. The method of claim 68, wherein:
applying the functional layer includes at least one of the printing methods of the group consisting of offset printing, screen printing, dabber stamping, gravure printing, letterpress printing and flexographic printing.

70. The method of claim 49, wherein:
forming the first insulating layer includes forming the first insulating layer on a transparent, substrate such that is roughened on a first surface, wherein the first insulating layer is formed on a second surface of the substrate.
